(19) United States
(12) Patent Application Publication
(10) Pub. No.: US 2026/0322459 A1
(43) Pub. Date: Oct. 15, 2026

(54) PRECODING METHOD AND APPARATUS

(71) Applicant: Beijing Xiaomi Mobile Software Co., Ltd., Beijing (CN)

(72) Inventors: Liangang CHI, Beijing (CN); Li YANG, Beijing (CN)

(73) Assignee: Beijing Xiaomi Mobile Software Co., Ltd., Beijing (CN)

(21) Appl. No.: 19/122,428

(22) PCT Filed: Oct. 19, 2022
(86) PCT No.: PCT/CN2022/126285

§ 371 Date: Apr. 18, 2025

(51) Int. Cl. H04B 7/06

(52) U.S. Cl. CPC H04B 7/0639; H04B 7/06952

(57) ABSTRACT

A precoding method, which is performed by a first network device and includes: determining phase shift matrix indication information for a second network device; and sending the phase shift matrix indication information to the second network device.

### CROSS-REFERENCE TO RELATED APPLICATION

This application is the U.S. national phase application of International Application No. PCT/CN2022/126285, filed on Oct. 19, 2022, the disclosure of which is incorporated herein by reference in its entirety for all purposes.

### TECHNICAL FIELD

The present disclosure relates to the field of wireless communication technologies, and in particular, to a precoding method and apparatus.

### BACKGROUND

A wireless environment is an uncontrollable factor in traditional communications, and its uncontrollability usually has a negative impact on communication efficiency and leads to a reduction in service quality. Signal attenuations limit propagation distances of wireless signals, multipath effects cause fading, and reflections and refractions from large objects are also major uncontrollable factors. By deploying a reconfigurable intelligent surface (RIS) on surfaces of various objects in the wireless transmission environment, it is expected to overcome the uncontrollability of traditional wireless channels, establish an intelligent programmable wireless, and introduce a new paradigm for future wireless communications. Particularly, the RIS may use a precoding technology to reflect the signal incident on its surface in a specific direction, thereby increasing a signal strength at a receiver and achieving channel control.

At present, the RIS precoding technology has become hot research in academia. In the academia, an alternating optimization technology is mainly adopted to take a joint design for the precoding at the RIS and the precoding at a base station. However, during the joint designing process, iterative calculations have to be performed continuously in accordance with corresponding adopted communication algorithms to determine a precoding matrix of the RIS, which increases the complexity of the precoding, thereby resulting in a low precoding efficiency and making it unsuitable for practical applications.

### SUMMARY

The present disclosure provides a precoding method and apparatus, which can simplify a precoding process of a reconfigurable intelligent surface (RIS), reduce a precoding complexity, and improve a precoding efficiency.

Examples in a first aspect of the present disclosure provide a precoding method, which is performed by a first network device and includes: determining phase shift matrix indication information for a second network device; and sending the phase shift matrix indication information to the second network device.

Examples in a second aspect of the present disclosure provide a precoding method, which is performed by a second network device and includes: receiving phase shift matrix indication information sent by a first network device; and performing a signal processing on one or more transmitted signals from the first network device in accordance with the phase shift matrix indication information.

Examples in a third aspect of the present disclosure provide a precoding method, which is performed by a terminal and includes: reporting a PMI for a second network device and beam quality information corresponding to the PMI to a first network device.

For additional aspects and advantages of the present disclosure, a part of them will be set forth in the following description, and another part of them will be apparent according to the following description or be learned through putting the present disclosure into practice.

### BRIEF DESCRIPTION OF THE DRAWINGS

The above and/or additional aspects and advantages of the present disclosure will become apparent and readily understood according to the following description of the examples in conjunction with the accompanying drawings.

FIG. 1 is a schematic flowchart of a precoding method according to an example of the present disclosure.

FIG. 2 is a schematic flowchart of a precoding method according to an example of the present disclosure.

FIG. 3 is a schematic flowchart of a precoding method according to an example of the present disclosure.

FIG. 4 is a schematic flowchart of a precoding method according to an example of the present disclosure.

FIG. 5 is a schematic flowchart of a precoding method according to an example of the present disclosure.

FIG. 6 is a schematic flowchart of a precoding method according to an example of the present disclosure.

FIG. 7 is a schematic flowchart of a precoding method according to an example of the present disclosure.

FIG. 8 is a schematic flowchart of a precoding method according to an example of the present disclosure.

FIG. 9 is a schematic flowchart of a precoding method according to an example of the present disclosure.

FIG. 10 is a schematic flowchart of a precoding method according to an example of the present disclosure.

FIG. 11 is a schematic flowchart of a precoding method according to an example of the present disclosure.

FIG. 12 is a block diagram of a precoding apparatus according to an example of the present disclosure.

FIG. 13 is a block diagram of a precoding apparatus according to an example of the present disclosure.

FIG. 14 is a block diagram of a precoding apparatus according to an example of the present disclosure.

FIG. 15 is a schematic structural diagram of a communication device according to an example of the present disclosure.

FIG. 16 is a schematic structure diagram of a chip provided in an example of the present disclosure.

### DETAILED DESCRIPTION OF THE EMBODIMENTS

Examples of the present disclosure are described in detail below, whose illustrations are shown in the accompanying drawings. The same or similar reference numerals throughout represent the same or similar elements or elements having the same or similar functions. The examples, which are described below with reference to the accompanying drawings, are illustrated and are intended to explain the present disclosure, but should not be construed as a limitation of the present disclosure.

In a communication system assisted by a reconfigurable intelligent surface (RIS), a base station reflects signals to a terminal via the RIS. Each unit of the RIS may perform a different phase shift on the received signal, thereby achieving an effect that a direction of a reflected beam may be adjusted. Meanwhile, existing studies have shown that offset phase angles of the RIS units may only be a few discrete values. In order to reflect incident signals of the RIS to a receiver, offset phases of the RIS units are expected to be configured, which means a precoding. At present, the RIS precoding technology has become hot research in academia. In the academia, an alternating optimization technology is mainly adopted to take a joint design for the precoding at the RIS and the precoding at the base station. However, during the joint designing process, iterative calculations have to be performed continuously in accordance with corresponding adopted communication algorithms to determine a precoding matrix of the RIS, which increases the complexity of the precoding, thereby resulting in a low precoding efficiency and making it unsuitable for practical applications.

In view of the above, the present disclosure provides a precoding method and apparatus, which can simplify a precoding process of the RIS, reduce a precoding complexity, and improve a precoding efficiency.

The examples of the present disclosure provide a precoding method and apparatus. By determining phase shift matrix indication information for a second network device (an RIS), a first network device (a base station) may send phase shift matrix indication information to the second network device, so that the second network device may perform a signal processing on transmitted signals from the first network device in accordance with phase shift matrix indication information. According to the present disclosure, the phase shift matrix indication information including precoding information is capable of being determined in the first network device through a simple data processing, so that the second network device may directly perform a phase shift matrix configuration according to the phase shift matrix indication information and perform the signal processing on the transmitted signals from the first network device. Therefore, the present disclosure can avoid adopting complex algorithms to take a joint design for the precoding at the RIS and the precoding at the base station, thereby simplifying the precoding process of the RIS, reducing the precoding complexity, and improving the precoding efficiency.

The precoding methods and apparatuses provided in the present disclosure are described in detail below in conjunction with the accompanying drawings.

FIG. 1 illustrates a schematic flowchart of a precoding method according to an example of the present disclosure. As illustrated in FIG. 1, the method is performed by a first network device. The first network device may be a base station. The example may include the following steps.

At step 101, phase shift matrix indication information for a second network device is determined.

Particularly, the second network device may be an RIS. The phase shift matrix indication information is used to determine a phase shift matrix configuration of the second network device, so that the second network device performs a signal reflection processing or a signal transmission processing on one or more transmitted signals from the first network device in accordance with the phase shift matrix configuration. Accordingly, a specific implementation process of determining the phase shift matrix indication information for the second network device may include the following.

(1) One or more terminals report one or more precoding matrix indicators (PMIs) for the second network device to the first network device. In addition, beam quality information corresponding to the one or more PMIs or other information that may be used to determine a beam weight (such as priority information of the one or more terminals) may also be reported to the first network device.

Particularly, the beam quality information corresponding to the PMI reflects a quality of a beam transmission. In specific application scenarios, the quality may be measured using a reference signal receiving power (RSRP), a signal to interference plus noise ratio (SINR), a reference signal received quality (RSRQ), a received signal strength indicator (RSSI), etc. For example, as a possible implementation, one piece of the mentioned information may be taken as the beam quality information corresponding to the PMI; and as a possible implementation, multiple pieces of the mentioned information may be integrated in accordance with a preset algorithm (such as a weighted integration) to obtain the beam quality information corresponding to the PMI.

(2) The first network device determines the phase shift matrix indication information for the second network device according to the information reported by the terminal.

Particularly, the phase shift matrix indication information for the second network device may include any one of first phase shift matrix indication information, second phase shift matrix indication information, third phase shift matrix indication information or fourth phase shift matrix indication information. The first phase shift matrix indication information may include incidence angle information of the one or more transmitted signals, the PMIs for the second network device reported by a plurality of terminals and beam quality information corresponding to the PMIs reported by the plurality of terminals. The second phase shift matrix indication information may include the incidence angle information of the one or more transmitted signals and second reflection angle information or second transmission angle information of the second network device. The third phase shift matrix indication information may include a phase shift matrix of the second network device. The fourth phase shift matrix indication information may include a phase shift matrix PMI.

Accordingly, a specific implementation process of determining the first phase shift matrix indication information by the first network device according to the information reported by the terminals may refer to the relevant description about steps 201 to 203 in an example. A specific implementation process of determining the second phase shift matrix indication information by the first network device according to the information reported by the terminals may refer to the relevant description about steps 301 to 303 in an example. A specific implementation process of determining the third phase shift matrix indication information by the first network device according to the information reported by the terminals may refer to the relevant description about steps 401 to 405 in an example. A specific implementation process of determining the fourth phase shift matrix indication information by the first network device according to the information reported by the terminals may refer to the relevant description about steps 501 to 505 in an example.

At step 102, the phase shift matrix indication information is sent to the second network device.

With respect to the example of the present disclosure, the steps of the example may include: sending any one of the first phase shift matrix indication information, the second phase shift matrix indication information, the third phase shift matrix indication information, or the fourth phase shift matrix indication information to the second network device. Therefore, the second network device determines the phase shift matrix configuration according to any one of the first phase shift matrix indication information, the second phase shift matrix indication information, the third phase shift matrix indication information or the fourth phase shift matrix indication information, and performs the signal reflection processing or the signal transmission processing on transmitted signals from the first network device in accordance with the phase shift matrix configuration.

In summary, according to the precoding method provided in the example of the present disclosure, by determining the phase shift matrix indication information for the second network device (the RIS), the first network device (the base station) may send the phase shift matrix indication information to the second network device, so that the second network device may perform the signal processing on the transmitted signals from the first network device in accordance with the phase shift matrix indication information. According to the present disclosure, the phase shift matrix indication information including precoding information is capable of being determined in the first network device through a simple data processing, so that the second network device may directly perform the phase shift matrix configuration according to the phase shift matrix indication information and perform the signal processing on the transmitted signals from the first network device. Therefore, the present disclosure can avoid iterative calculations and complex algorithms, thereby simplifying the precoding process of the RIS, reducing the precoding complexity, and improving the precoding efficiency.

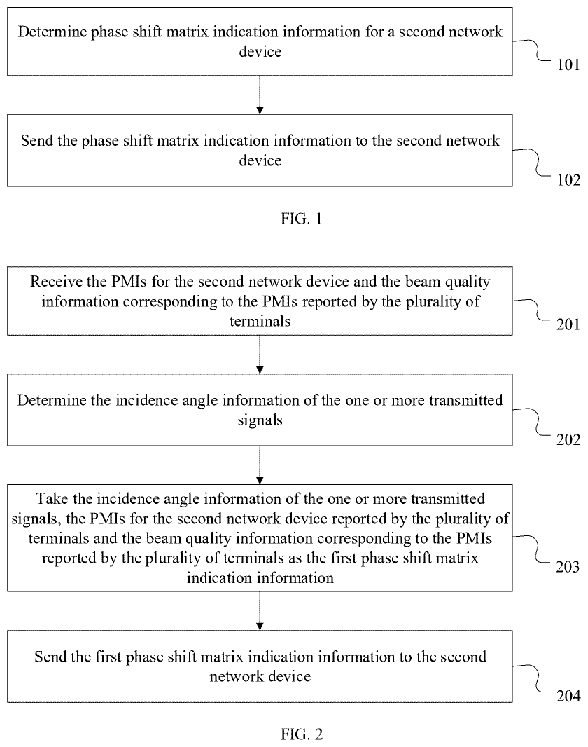

FIG. 2 illustrates a precoding method according to an example of the present disclosure, which is performed by a first network device. On the basis of the example illustrated in FIG. 1 and as illustrated in FIG. 2, the method may include the following steps.

At step 201, the PMIs for the second network device and the beam quality information corresponding to the PMIs reported by the plurality of terminals are received.

At step 202, the incidence angle information of the one or more transmitted signals is determined.

The incidence angle information refers to angles of the one or more transmitted signals transmitted by the first network device (the base station) incident on the second network device (the RIS), which may be determined by the base station in several alternative or additional ways, such as a channel estimation, a protocol agreement, or a sensing on information fed back from the RIS.

At step 203, the incidence angle information of the one or more transmitted signals, the PMIs for the second network device reported by the plurality of terminals and the beam quality information corresponding to the PMIs reported by the plurality of terminals are taken as the first phase shift matrix indication information.

At step 204, the first phase shift matrix indication information is sent to the second network device.

In summary, according to the precoding method provided in the example of the present disclosure, the first network device (the base station) may directly take the incidence angle information of the one or more transmitted signals, the PMIs for the second network device reported by the plurality of terminals and the beam quality information corresponding to the PMIs reported by the plurality of terminals as the first phase shift matrix indication information, and send the first phase shift matrix indication information to the second network device, so that the second network device is capable of performing the signal processing on the transmitted signals from the first network device in accordance with the first phase shift matrix indication information. Since the first phase shift matrix indication information includes the precoding information or the beam information, the second network device may directly perform the phase shift matrix configuration according to the first phase shift matrix indication information and perform the signal processing on the transmitted signals from the first network device. Therefore, the present disclosure can avoid iterative calculations and complex algorithms, thereby simplifying the precoding process of the RIS, reducing the precoding complexity, and improving the precoding efficiency.

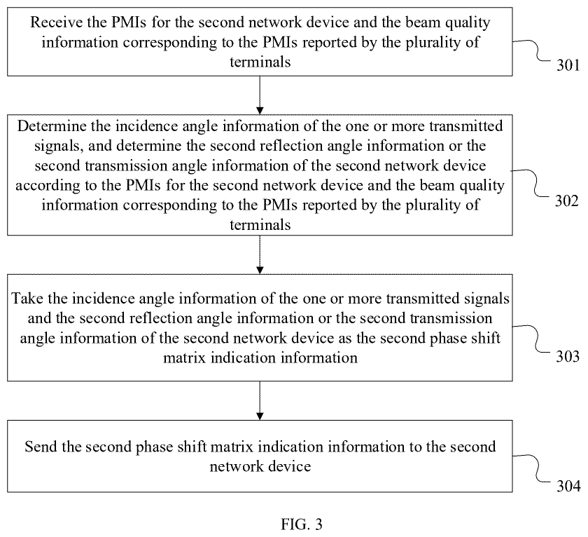

FIG. 3 illustrates a precoding method according to an example of the present disclosure, which is performed by a first network device. On the basis of the example illustrated in FIG. 1 and as illustrated in FIG. 3, the method may include the following steps.

At step 301, the PMIs for the second network device and the beam quality information corresponding to the PMIs reported by the plurality of terminals are received.

At step 302, the incidence angle information of the one or more transmitted signals is determined, and the second reflection angle information or the second transmission angle information of the second network device is determined according to the PMIs for the second network device and the beam quality information corresponding to the PMIs reported by the plurality of terminals.

With respect to the example of the present disclosure, when determining the second reflection angle information or the second transmission angle information of the second network device according to the PMIs for the second network device and the beam quality information corresponding to the PMIs reported by the plurality of terminals, the steps of the example may specifically include: determining first reflection angle information or first transmission angle information of the plurality of terminals according to the PMIs for the second network device reported by the plurality of terminals, and determining the second reflection angle information or the second transmission angle information of the second network device according to the first reflection angle information or the first transmission angle information of the plurality of terminals, the PMIs for the second network device reported by the plurality of terminals and the beam quality information corresponding to the PMIs reported by the plurality of terminals. Particularly, the reflection angle information and the transmission angle information may be jointly represented with two dimensions, where the first dimension is a horizontal dimension and the second dimension is a vertical dimension. That is, the first reflection angle information of the plurality of terminals includes first reflection angle information in horizontal dimension and first reflection angle information in vertical dimension, and the first transmission angle information of the plurality of terminals includes first transmission angle information in horizontal dimension and first transmission angle information in vertical dimension. Correspondingly, the second reflection angle information of the second network device includes second reflection angle information in horizontal dimension and second reflection angle information in vertical dimension, and the second transmission angle information of the second network device includes second transmission angle information in horizontal dimension and second transmission angle information in vertical dimension.

Accordingly, when determining the second reflection angle information or the second transmission angle information of the second network device, at least one type, the PMIs for the second network device or the beam quality information corresponding to the PMIs reported by the plurality of terminals, may be used together with the first reflection angle information or the first transmission angle information of the plurality of terminals to determine the second reflection angle information or the second transmission angle information of the second network device. That is, the second reflection angle information or the second transmission angle information of the second network device may be determined using the beam quality information corresponding to the PMIs reported by the plurality of terminals and the first reflection angle information or the first transmission angle information of the plurality of terminals. Alternatively, the second reflection angle information or the second transmission angle information of the second network device may be determined using the PMIs for the second network device reported by the plurality of terminals and the first reflection angle information or the first transmission angle information of the plurality of terminals. Alternatively, the second reflection angle information or the second transmission angle information of the second network device may be determined jointly using the PMIs for the second network device reported by the plurality of terminals, the beam quality information corresponding to the PMIs reported by the plurality of terminals and the first reflection angle information or the first transmission angle information of the plurality of terminals together.

As a possible implementation, the second reflection angle information or the second transmission angle information of the second network device may be determined by weighting. Particularly, a weight of each terminal may be calculated based on at least one of the PMI for the second network device and the beam quality information corresponding to the PMI, and the second reflection angle information or the second transmission angle information of the second network device may be determined by weighting the first reflection angle information or the first transmission angle information of the plurality of terminals with the weights. For example, when calculating the weight of each terminal based on the beam quality information corresponding to the PMI, it takes three terminals in horizontal dimension as an example, where the angles corresponding to the first reflection angle information in horizontal dimension or the first transmission angle information in horizontal dimension are α₁, α₂, and α₃, respectively, and the corresponding beam qualities are b₁, b₂, and b₃, respectively. Thus, the second reflection angle information in horizontal dimension or the second transmission angle information in horizontal dimension used by the RIS is c₁*α₁+c₂*α₂+c₃*α₃. The c₁, c₂, c₃ ∈[0,1], c₁+c₂+c₃=1, and c₁, c₂, c₃ are the weights corresponding to α₁, α₂, and α₃ and are determined based on b₁, b₂, and b₃. As an example of determining the weights,

$${c}_{1} = \frac{{b}_{1}}{{b}_{1} + {b}_{2} + {b}_{3}} , {c}_{2} = \frac{{b}_{2}}{{b}_{1} + {b}_{2} + {b}_{3}} , {c}_{3} = \frac{{b}_{3}}{{b}_{1} + {b}_{2} + {b}_{3}} .$$

Correspondingly, it is determined in vertical dimension in the same way, which will not be repeated here. Accordingly, the steps in the example may include: determining the beam weights corresponding to the terminals based on the PMIs for the second network device and the beam quality information corresponding to the PMIs reported by the plurality of terminals, and obtaining the second reflection angle information or the second transmission angle information of the second network device by performing a weighted processing on angle values of the first reflection angle information or the first transmission angle information of the plurality of terminals using the beam weights corresponding to the terminals.

As a possible implementation, it may take a direction with the best beam quality from the first reflection angle information or the first transmission angle information corresponding to the plurality of terminals as the second reflection angle information or the second transmission angle information of the second network device. That is, in the corresponding weighted way, the weight of the first reflection angle information or the first transmission angle information with the best beam quality is set to 1, and the weights of other directions are set to 0. The beam quality may be determined according to at least one of the PMI of the second network device and the beam quality information corresponding to the PMI. In the example of the present disclosure, it may take the first reflection angle information in horizontal dimension with the best beam quality among the plurality of pieces of first reflection angle information in horizontal dimension corresponding to the plurality of terminals as the second reflection angle information in horizontal dimension of the second network device, and take the first reflection angle information in vertical dimension with the best beam quality among the plurality of pieces of first reflection angle information in vertical dimension corresponding to the plurality of terminals as the second reflection angle information in vertical dimension of the second network device. Accordingly, the steps of the example may further include: determining, according to the PMIs for the second network device and the beam quality information corresponding to the PMIs reported by the plurality of terminals, a piece of first reflection angle information or first transmission angle information that meets a preset condition among the first reflection angle information or the first transmission angle information of the plurality of terminals as the second reflection angle information or the second transmission angle information of the second network device. Particularly, the preset condition may be the beam quality being best, or other filtering conditions may be set in combination with actual application scenarios, which are not exhaustively listed here.

At step 303, the incidence angle information of the one or more transmitted signals and the second reflection angle information or the second transmission angle information of the second network device are taken as the second phase shift matrix indication information.

At step 304, the second phase shift matrix indication information is sent to the second network device.

In summary, according to the precoding method provided in the example of the present disclosure, after receiving the PMIs for the second network device and the beam quality information corresponding to the PMIs reported by the plurality of terminals, the first network device (the base station) may determine the incidence angle information of the one or more transmitted signals, determine the second reflection angle information or the second transmission angle information of the second network device according to the PMIs for the second network device and the beam quality information corresponding to the PMIs reported by the plurality of terminals, then take the incidence angle information of the one or more transmitted signals and the second reflection angle information or the second transmission angle information of the second network device as the second phase shift matrix indication information, and send the second phase shift matrix indication information to the second network device, so that the second network device is capable of performing the signal processing on the transmitted signals from the first network device in accordance with the second phase shift matrix indication information. Since the second phase shift matrix indication information includes the precoding information or the beam information, the second network device may directly perform the phase shift matrix configuration according to the second phase shift matrix indication information and perform the signal processing on the transmitted signals from the first network device. Therefore, the present disclosure can avoid iterative calculations and complex algorithms, thereby simplifying the precoding process of the RIS, reducing the precoding complexity, and improving the precoding efficiency.

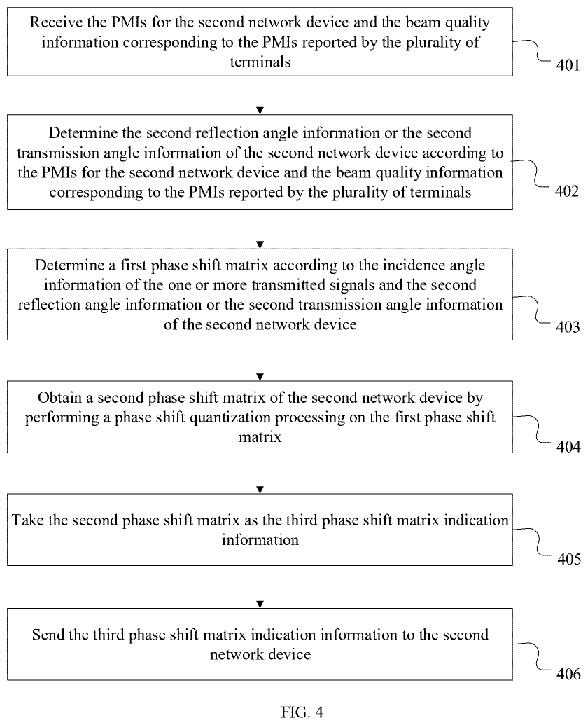

FIG. 4 illustrates a precoding method according to an example of the present disclosure, which is performed by a first network device. On the basis of the example illustrated in FIG. 1 and as illustrated in FIG. 4, the method may include the following steps.

At step 401, the PMIs for the second network device and the beam quality information corresponding to the PMIs reported by the plurality of terminals are received.

At step 402, the second reflection angle information or the second transmission angle information of the second network device is determined according to the PMIs for the second network device and the beam quality information corresponding to the PMIs reported by the plurality of terminals.

With respect to the example of the present disclosure, it may refer to the relevant description about step 302 in the example for details, which will not be repeated here.

At step 403, a first phase shift matrix is determined according to the incidence angle information of the one or more transmitted signals and the second reflection angle information or the second transmission angle information of the second network device.

With respect to the example of the present disclosure, as a possible implementation, a first phase shift matrix for supporting the signal reflection processing may be calculated according to the incidence angle information of the one or more transmitted signals and the second reflection angle information of the second network device, and as a possible implementation, a first phase shift matrix for supporting the signal transmission processing may be calculated according to the incidence angle information of the one or more transmitted signals and the second transmission angle information of the second network device.

At step 404, a second phase shift matrix of the second network device is obtained by performing a phase shift quantization processing on the first phase shift matrix.

In specific application scenarios, since the first phase shift matrix is a continuous phase shift matrix calculated according to the incidence angle information and the second reflection angle information or the second transmission angle information with continuous phases, while the phases of the RIS may include only a few discrete phases, it is further expected to perform the phase shift quantization processing on the first phase shift matrix after the first phase shift matrix is calculated and obtained, so as to quantize a phase shift of each unit of the first phase shift matrix to the phase shifts supported by the RIS. Particularly, it may quantize the phase shift of each unit of the first phase shift matrix to a discrete phase shift closest to the obtained phase shift by a minimum distance criterion. After the phase shift quantization is complete, the second phase shift matrix of the second network device is further obtained.

At step 405, the second phase shift matrix is taken as the third phase shift matrix indication information.

At step 406, the third phase shift matrix indication information is sent to the second network device.

In summary, according to the precoding method provided in the example of the present disclosure, after receiving the PMIs for the second network device and the beam quality information corresponding to the PMIs reported by the plurality of terminals, the first network device (the base station) may determine the incidence angle information of the one or more transmitted signals, determine the second reflection angle information or the second transmission angle information of the second network device according to the PMIs for the second network device and the beam quality information corresponding to the PMIs reported by the plurality of terminals, then determine the first phase shift matrix according to the incidence angle information of the one or more transmitted signals and the second reflection angle information or the second transmission angle information of the second network device, obtain the second phase shift matrix of the second network device by performing the phase shift quantization processing on the first phase shift matrix, then take the second phase shift matrix as the third phase shift matrix indication information, and send the third phase shift matrix indication information to the second network device, so that the second network device is capable of performing the signal processing on the transmitted signals from the first network device in accordance with the third phase shift matrix indication information. Since the third phase shift matrix indication information includes the precoding information or the beam information, the second network device may directly perform the phase shift matrix configuration according to the third phase shift matrix indication information and perform the signal processing on the transmitted signals from the first network device. Therefore, the present disclosure can avoid iterative calculations and complex algorithms, thereby simplifying the precoding process of the RIS, reducing the precoding complexity, and improving the precoding efficiency.

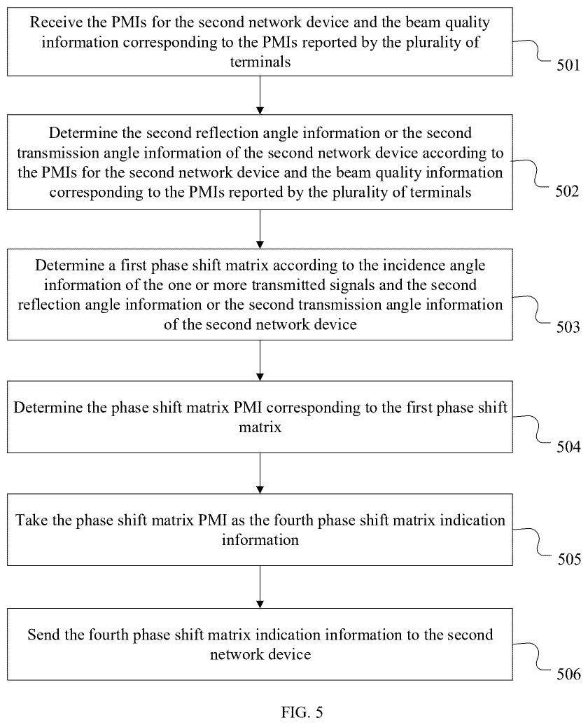

FIG. 5 illustrates a precoding method according to an example of the present disclosure, which is performed by a first network device. On the basis of the example illustrated in FIG. 1 and as illustrated in FIG. 5, the method may include the following steps.

At step 501, the PMIs for the second network device and the beam quality information corresponding to the PMIs reported by the plurality of terminals are received.

At step 502, the second reflection angle information or the second transmission angle information of the second network device is determined according to the PMIs for the second network device and the beam quality information corresponding to the PMIs reported by the plurality of terminals.

With respect to the example of the present disclosure, it may refer to the relevant description about step 302 in the example for details, which will not be repeated here.

At step 503, a first phase shift matrix is determined according to the incidence angle information of the one or more transmitted signals and the second reflection angle information or the second transmission angle information of the second network device.

At step 504, the phase shift matrix PMI corresponding to the first phase shift matrix is determined.

With respect to the example of the present disclosure, after the first phase shift matrix is determined and obtained, the phase shift matrix PMI corresponding to a first phase shift matrix may be extracted, so as to directly take the phase shift matrix PMI as the fourth phase shift matrix indication information.

At step 505, the phase shift matrix PMI is taken as the fourth phase shift matrix indication information.

At step 506, the fourth phase shift matrix indication information is sent to the second network device.

In summary, according to the precoding method provided in the example of the present disclosure, after receiving the PMIs for the second network device and the beam quality information corresponding to the PMIs reported by the plurality of terminals, the first network device (the base station) may determine the incidence angle information of the one or more transmitted signals, determine the second reflection angle information or the second transmission angle information of the second network device according to the PMIs for the second network device and the beam quality information corresponding to the PMIs reported by the plurality of terminals, then determine the first phase shift matrix according to the incidence angle information of the one or more transmitted signals and the second reflection angle information or the second transmission angle information of the second network device, determine the phase shift matrix PMI corresponding to the first phase shift matrix, then take the phase shift matrix PMI as the fourth phase shift matrix indication information and send it to the second network device, so that the second network device may directly perform the phase shift matrix configuration according to the fourth phase shift matrix indication information and perform the signal processing on the transmitted signals from the first network device. Therefore, the present disclosure can avoid iterative calculations and complex algorithms, thereby simplifying the precoding process of the RIS, reducing the precoding complexity, and improving the precoding efficiency.

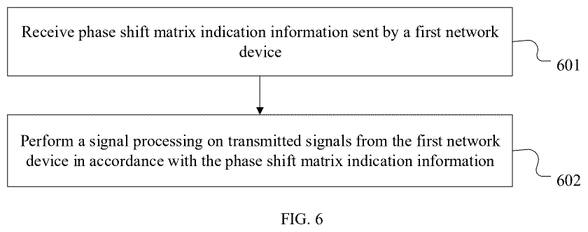

FIG. 6 is a schematic flowchart of a precoding method according to an example of the present disclosure. The method is performed by a second network device. The second network device may be an RIS. The example may include the following steps.

At step 601, phase shift matrix indication information sent by a first network device is received.

Particularly, the phase shift matrix indication information may be determined by the first network device according to information reported by one or more terminals after receiving the information reported by the one or more terminals. The information reported by the one or more terminals may include PMIs for the second network device and beam quality information corresponding to the PMIs, etc. The phase shift matrix indication information is used to determine a phase shift matrix configuration of the second network device, so that the second network device performs a signal reflection processing or a signal transmission processing on transmitted signals from the first network device in accordance with the phase shift matrix configuration. Particularly, the phase shift matrix indication information for the second network device may include any one of first phase shift matrix indication information, second phase shift matrix indication information, third phase shift matrix indication information or fourth phase shift matrix indication information. The first phase shift matrix indication information may include incidence angle information of the one or more transmitted signals, the PMIs for the second network device reported by a plurality of terminals and beam quality information corresponding to the PMIs reported by the plurality of terminals. The second phase shift matrix indication information may include the incidence angle information of the one or more transmitted signals and second reflection angle information or second transmission angle information of the second network device. The third phase shift matrix indication information may include a phase shift matrix of the second network device. The fourth phase shift matrix indication information may include a phase shift matrix PMI.

At step 602, a signal processing is performed on transmitted signals from the first network device in accordance with the phase shift matrix indication information.

With respect to the example of the present disclosure, the second network device may determine the phase shift matrix configuration according to any one of the first phase shift matrix indication information, the second phase shift matrix indication information, the third phase shift matrix indication information, or the fourth phase shift matrix indication information, and perform the signal reflection processing or the signal transmission processing on the transmitted signals from the first network device in accordance with the phase shift matrix configuration. Particularly, a specific implementation process that the second network device performs the signal processing on the transmitted signals from the first network device in accordance with the first phase shift matrix indication information may refer to the relevant description about steps 701 to 706 in an example. A specific implementation process that the second network device performs the signal processing on the transmitted signals from the first network device in accordance with the second phase shift matrix indication information may refer to the relevant description about steps 801 to 805 in an example. A specific implementation process that the second network device performs the signal processing on the transmitted signals from the first network device in accordance with the third phase shift matrix indication information may refer to the relevant description about steps 901 to 903 in an example. A specific implementation process that the second network device performs the signal processing on the transmitted signals from the first network device in accordance with the fourth phase shift matrix indication information may refer to the relevant description about steps 1001 to 1005 in an example.

In summary, according to the precoding method provided in the example of the present disclosure, after receiving the phase shift matrix indication information sent by the first network device (a base station), the second network device (the RIS) may perform the signal processing on the transmitted signals from the first network device in accordance with the phase shift matrix indication information. Through the simple data processing in the present disclosure, the second network device may directly perform the phase shift matrix configuration according to the phase shift matrix indication information and perform the signal processing on the transmitted signals from the first network device. Therefore, iterative calculations and complex algorithms can be avoided, thereby simplifying the precoding process of the RIS, reducing the precoding complexity, and improving the precoding efficiency.

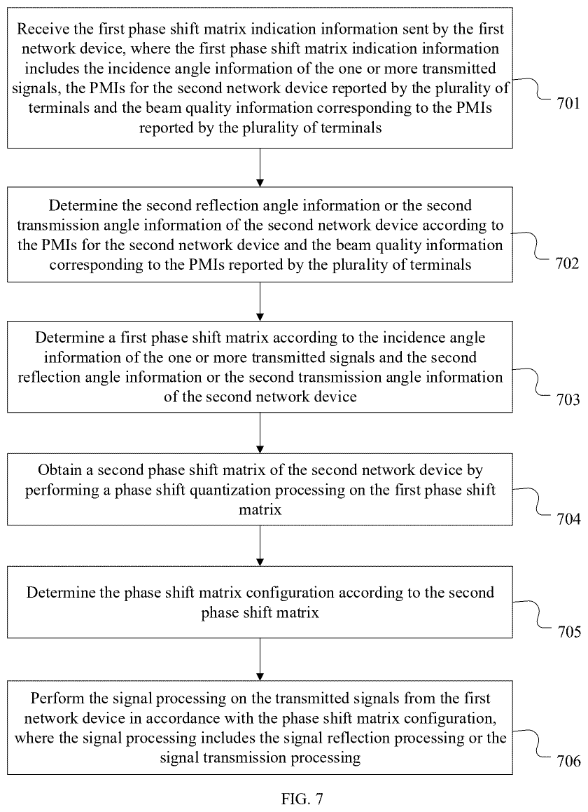

FIG. 7 illustrates a precoding method according to an example of the present disclosure, which is performed by a second network device. On the basis of the example illustrated in FIG. 6 and as illustrated in FIG. 7, the method may include the following steps.

At step 701, the first phase shift matrix indication information sent by the first network device is received, where the first phase shift matrix indication information includes the incidence angle information of the one or more transmitted signals, the PMIs for the second network device reported by the plurality of terminals and the beam quality information corresponding to the PMIs reported by the plurality of terminals.

In specific application scenarios, the first network device may determine the first phase shift matrix indication information and send the first phase shift matrix indication information to the second network device through steps 201 to 204 of the example. Accordingly, the second network device may receive the incidence angle information of the one or more transmitted signals, the PMIs for the second network device reported by the plurality of terminals and the beam quality information corresponding to the PMIs reported by the plurality of terminals.

At step 702, the second reflection angle information or the second transmission angle information of the second network device is determined according to the PMIs for the second network device and the beam quality information corresponding to the PMIs reported by the plurality of terminals.

With respect to the example of the present disclosure, when determining the second reflection angle information or the second transmission angle information of the second network device according to the PMIs for the second network device and the beam quality information corresponding to the PMIs reported by the plurality of terminals, the steps of the example may specifically include: determining first reflection angle information or first transmission angle information of the plurality of terminals according to the PMIs for the second network device reported by the plurality of terminals, and determining the second reflection angle information or the second transmission angle information of the second network device according to the first reflection angle information or the first transmission angle information of the plurality of terminals, the PMIs for the second network device reported by the plurality of terminals and the beam quality information corresponding to the PMIs reported by the plurality of terminals. Particularly, the reflection angle information and the transmission angle information may be jointly represented with two dimensions, where the first dimension is a horizontal dimension and the second dimension is a vertical dimension. That is, the first reflection angle information of the plurality of terminals includes first reflection angle information in horizontal dimension and first reflection angle information in vertical dimension, and the first transmission angle information of the plurality of terminals includes first transmission angle information in horizontal dimension and first transmission angle information in vertical dimension. Correspondingly, the second reflection angle information of the second network device includes second reflection angle information in horizontal dimension and second reflection angle information in vertical dimension, and the second transmission angle information of the second network device includes second transmission angle information in horizontal dimension and second transmission angle information in vertical dimension.

When determining the second reflection angle information or the second transmission angle information of the second network device, at least one type, the PMIs for the second network device or the beam quality information corresponding to the PMIs reported by the plurality of terminals, may be used together with the first reflection angle information or the first transmission angle information of the plurality of terminals to determine the second reflection angle information or the second transmission angle information of the second network device. That is, the second reflection angle information or the second transmission angle information of the second network device may be determined using the beam quality information corresponding to the PMIs reported by the plurality of terminals and the first reflection angle information or the first transmission angle information of the plurality of terminals. Alternatively, the second reflection angle information or the second transmission angle information of the second network device may be determined using the PMIs for the second network device reported by the plurality of terminals and the first reflection angle information or the first transmission angle information of the plurality of terminals. Alternatively, the second reflection angle information or the second transmission angle information of the second network device may be determined jointly using the PMIs for the second network device reported by the plurality of terminals, the beam quality information corresponding to the PMIs reported by the plurality of terminals and the first reflection angle information or the first transmission angle information of the plurality of terminals together.

As a possible implementation, the second reflection angle information or the second transmission angle information of the second network device may be determined by weighting. Particularly, a weight of each terminal may be calculated based on at least one of the PMI for the second network device and the beam quality information corresponding to the PMI, and the second reflection angle information or the second transmission angle information of the second network device may be determined by weighting the first reflection angle information or the first transmission angle information of the plurality of terminals with the weights. For example, when calculating the weight of each terminal based on the beam quality information corresponding to the PMI, it takes three terminals in horizontal dimension as an example, where the angles corresponding to the first reflection angle information in horizontal dimension or the first transmission angle information in horizontal dimension are α₁, α₂, and α₃, respectively, and the corresponding beam qualities are b₁, b₂, and b₃, respectively. Thus, the second reflection angle information in horizontal dimension or the second transmission angle information in horizontal dimension used by the RIS is c₁*α₁+c₂*α₂+c₃*α₃. The c₁, c₂, c₃ ∈[0,1], c₁+c₂+c₃=1, and c₁, c₂, c₃ are the weights corresponding to α₁, α₂, and α₃, and are determined based on b₁, b₂, and b₃. As an example of determining the weights,

$${c}_{1} = \frac{{b}_{1}}{{b}_{1} + {b}_{2} + {b}_{3}} , {c}_{2} = \frac{{b}_{2}}{{b}_{1} + {b}_{2} + {b}_{3}} , {c}_{3} = \frac{{b}_{3}}{{b}_{1} + {b}_{2} + {b}_{3}} .$$

Correspondingly, it is determined in vertical dimension in the same way, which will not be repeated here. Accordingly, the steps in the example may include: determining the beam weights corresponding to the terminals based on the PMIs for the second network device and the beam quality information corresponding to the PMIs reported by the plurality of terminals, and obtaining the second reflection angle information or the second transmission angle information of the second network device by performing a weighted processing on angle values of the first reflection angle information or the first transmission angle information of the plurality of terminals using the beam weights corresponding to the terminals.

As a possible implementation, it may take a direction with the best beam quality from the first reflection angle information or the first transmission angle information corresponding to the plurality of terminals as the second reflection angle information or the second transmission angle information of the second network device. That is, in the corresponding weighted way, the weight of the first reflection angle information or the first transmission angle information with the best beam quality is set to 1, and the weights of other directions are set to 0. The beam quality may be determined according to at least one of the PMI of the second network device and the beam quality information corresponding to the PMI. In the example of the present disclosure, it may take the first reflection angle information in horizontal dimension with the best beam quality among the plurality of pieces of first reflection angle information in horizontal dimension corresponding to the plurality of terminals as the second reflection angle information in horizontal dimension of the second network device, and take the first reflection angle information in vertical dimension with the best beam quality among the plurality of pieces of first reflection angle information in vertical dimension corresponding to the plurality of terminals as the second reflection angle information in vertical dimension of the second network device. Accordingly, the steps of the example may further include: determining, according to the PMIs for the second network device and the beam quality information corresponding to the PMIs reported by the plurality of terminals, a piece of first reflection angle information or first transmission angle information that meets a preset condition among the first reflection angle information or the first transmission angle information of the plurality of terminals as the second reflection angle information or the second transmission angle information of the second network device. Particularly, the preset condition may be the beam quality being best, or other filtering conditions may be set in combination with actual application scenarios, which are not exhaustively listed here.

At step 703, a first phase shift matrix is determined according to the incidence angle information of the one or more transmitted signals and the second reflection angle information or the second transmission angle information of the second network device.

With respect to the example of the present disclosure, as a possible implementation, a first phase shift matrix for supporting the signal reflection processing may be calculated according to the incidence angle information of the one or more transmitted signals and the second reflection angle information of the second network device, and as a possible implementation, the first phase shift matrix for supporting the signal transmission processing may be calculated according to the incidence angle information of the one or more transmitted signals and the second transmission angle information of the second network device.

At step 704, a second phase shift matrix of the second network device is obtained by performing a phase shift quantization processing on the first phase shift matrix.

In specific application scenarios, since the first phase shift matrix is a continuous phase shift matrix calculated according to the incidence angle information and the second reflection angle information or the second transmission angle information with continuous phases, while the phases of the RIS may include only a few discrete phases, it is further expected to perform the phase shift quantization processing on the first phase shift matrix after the first phase shift matrix is calculated and obtained, so as to quantize a phase shift of each unit of the first phase shift matrix to the phase shifts supported by the RIS. Particularly, it may quantize the phase shift of each unit of the first phase shift matrix to a discrete phase shift closest to the obtained phase shift by a minimum distance criterion. After the phase shift quantization is complete, the second phase shift matrix of the second network device is further obtained.

At step 705, the phase shift matrix configuration is determined according to the second phase shift matrix.

At step 706, the signal processing is performed on the transmitted signals from the first network device in accordance with the phase shift matrix configuration, where the signal processing includes the signal reflection processing or the signal transmission processing.

With respect to the example of the present disclosure, if the second phase shift matrix is a phase shift matrix supporting the signal reflection processing, the signal reflection processing may be performed on the transmitted signals from the first network device in accordance with the phase shift matrix configuration determined from the second phase shift matrix correspondingly, and if the second phase shift matrix is a phase shift matrix supporting the signal transmission processing, the signal transmission processing may be performed on the transmitted signals from the first network device in accordance with the phase shift matrix configuration determined from the second phase shift matrix correspondingly.

In summary, according to the precoding method provided in the example of the present disclosure, after receiving the first phase shift matrix indication information sent by the first network device (the base station), the second network device (the RIS) may generate the phase shift matrix configuration according to the first phase shift matrix indication information, and perform the signal processing on the transmitted signals from the first network device in accordance with the phase shift matrix configuration. Through the simple data processing in the present disclosure, the second network device may directly perform the phase shift matrix configuration according to the phase shift matrix indication information and perform the signal processing on the transmitted signals from the first network device. Therefore, iterative calculations and complex algorithms can be avoided, thereby simplifying the precoding process of the RIS, reducing the precoding complexity, and improving the precoding efficiency.

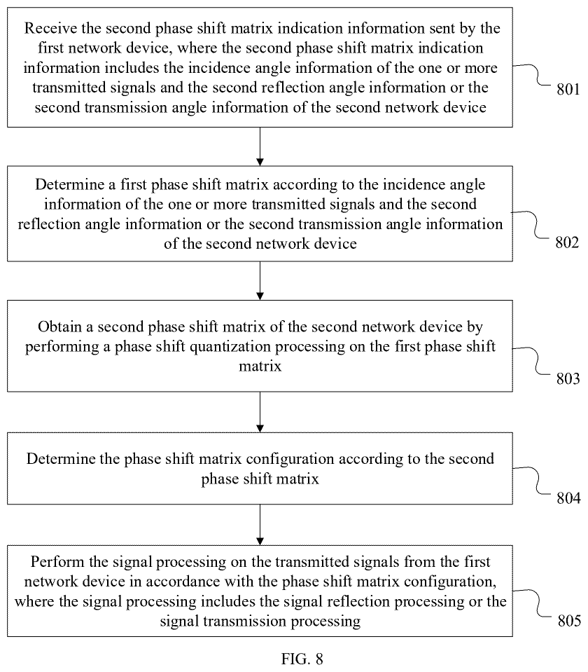

FIG. 8 illustrates a precoding method according to an example of the present disclosure, which is performed by a second network device. On the basis of the example illustrated in FIG. 6 and as illustrated in FIG. 8, the method may include the following steps.

At step 801, the second phase shift matrix indication information sent by the first network device is received, where the second phase shift matrix indication information includes the incidence angle information of the one or more transmitted signals and the second reflection angle information or the second transmission angle information of the second network device.

In specific application scenarios, the first network device may determine the second phase shift matrix indication information and send the second phase shift matrix indication information to the second network device through steps 301 to 304 of the example. Accordingly, the second network device may receive the incidence angle information of the one or more transmitted signals and the second reflection angle information or the second transmission angle information of the second network device.

At step 802, a first phase shift matrix is determined according to the incidence angle information of the one or more transmitted signals and the second reflection angle information or the second transmission angle information of the second network device.

At step 803, a second phase shift matrix of the second network device is obtained by performing a phase shift quantization processing on the first phase shift matrix.

At step 804, the phase shift matrix configuration is determined according to the second phase shift matrix.

At step 805, the signal processing is performed on the transmitted signals from the first network device in accordance with the phase shift matrix configuration, where the signal processing includes the signal reflection processing or the signal transmission processing.

In summary, according to the precoding method provided in the example of the present disclosure, after receiving the second phase shift matrix indication information sent by the first network device (the base station), the second network device (the RIS) may generate the phase shift matrix configuration according to the second phase shift matrix indication information, and perform the signal processing on the transmitted signals from the first network device in accordance with the phase shift matrix configuration. Through the simple data processing in the present disclosure, the second network device may directly perform the phase shift matrix configuration according to the second phase shift matrix indication information and perform the signal processing on the transmitted signals from the first network device. Therefore, iterative calculations and complex algorithms can be avoided, thereby simplifying the precoding process of the RIS, reducing the precoding complexity, and improving the precoding efficiency.

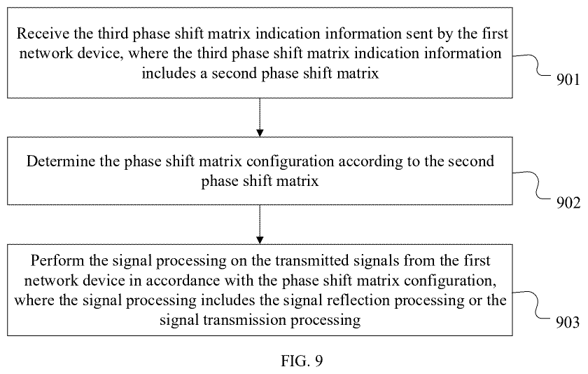

FIG. 9 illustrates a precoding method according to an example of the present disclosure, which is performed by a second network device. On the basis of the example illustrated in FIG. 6 and as illustrated in FIG. 9, the method may include the following steps.

At step 901, the third phase shift matrix indication information sent by the first network device is received, where the third phase shift matrix indication information includes a second phase shift matrix.

In specific application scenarios, the first network device may determine the third phase shift matrix indication information and send the third phase shift matrix indication information to the second network device through steps 401 to 406 of the example. Accordingly, the second network device may receive the second phase shift matrix.

At step 902, the phase shift matrix configuration is determined according to the second phase shift matrix.

At step 903, the signal processing is performed on the transmitted signals from the first network device in accordance with the phase shift matrix configuration, where the signal processing includes the signal reflection processing or the signal transmission processing.

In summary, according to the precoding method provided in the example of the present disclosure, after receiving the third phase shift matrix indication information sent by the first network device (the base station), the second network device (the RIS) may generate the phase shift matrix configuration according to the third phase shift matrix indication information, and perform the signal processing on the transmitted signals from the first network device in accordance with the phase shift matrix configuration. Through the simple data processing in the present disclosure, the second network device may directly perform the phase shift matrix configuration according to the third phase shift matrix indication information and perform the signal processing on the transmitted signals from the first network device. Therefore, iterative calculations and complex algorithms can be avoided, thereby simplifying the precoding process of the RIS, reducing the precoding complexity, and improving the precoding efficiency.

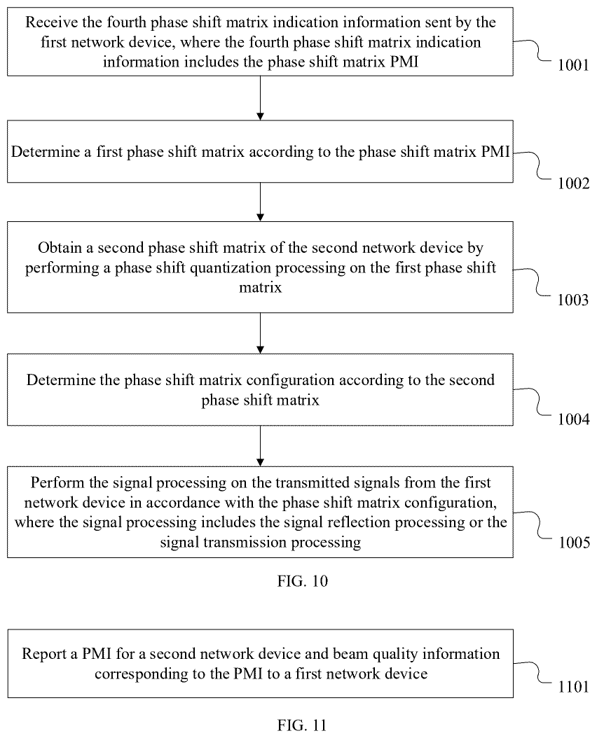

FIG. 10 illustrates a precoding method according to an example of the present disclosure, which is performed by a second network device. On the basis of the example illustrated in FIG. 6 and as illustrated in FIG. 10, the method may include the following steps.

At step 1001, the fourth phase shift matrix indication information sent by the first network device is received, where the fourth phase shift matrix indication information includes the phase shift matrix PMI.

In specific application scenarios, the first network device may determine the fourth phase shift matrix indication information and send the fourth phase shift matrix indication information to the second network device through steps 501 to 506 of the example. Correspondingly, the second network device may receive the phase shift matrix PMI.

At step 1002, a first phase shift matrix is determined according to the phase shift matrix PMI.

At step 1003, a second phase shift matrix of the second network device is obtained by performing a phase shift quantization processing on the first phase shift matrix.

In specific application scenarios, since the first phase shift matrix is a continuous phase shift matrix calculated according to the incidence angle information and the second reflection angle information or the second transmission angle information with continuous phases, while the phases of the RIS may include only a few discrete phases, it is further expected to perform the phase shift quantization processing on the first phase shift matrix after the first phase shift matrix is calculated and obtained, so as to quantize a phase shift of each unit of the first phase shift matrix to the phase shifts supported by the RIS. Particularly, it may quantize the phase shift of each unit of the first phase shift matrix to a discrete phase shift closest to the obtained phase shift by a minimum distance criterion. After the phase shift quantization is complete, the second phase shift matrix of the second network device is further obtained.

At step 1004, the phase shift matrix configuration is determined according to the second phase shift matrix.

At step 1005, the signal processing is performed on the transmitted signals from the first network device in accordance with the phase shift matrix configuration, where the signal processing includes the signal reflection processing or the signal transmission processing.

In summary, according to the precoding method provided in the example of the present disclosure, after receiving the fourth phase shift matrix indication information sent by the first network device (the base station), the second network device (the RIS) may generate the phase shift matrix configuration according to the fourth phase shift matrix indication information, and perform the signal processing on the transmitted signals from the first network device in accordance with the phase shift matrix configuration. According to the present disclosure, the second network device may directly perform the phase shift matrix configuration according to the fourth phase shift matrix indication information and perform the signal processing on the transmitted signals from the first network device. Therefore, iterative calculations and complex algorithms can be avoided, thereby simplifying the precoding process of the RIS, reducing the precoding complexity, and improving the precoding efficiency.

FIG. 11 is a schematic flowchart of a precoding method according to an example of the present disclosure. The method is performed by a terminal, and may include the following steps.

At step 1101, a PMI for a second network device and beam quality information corresponding to the PMI are reported to a first network device.

With respect to the example of the present disclosure, the terminal may report the PMI for the second network device and the beam quality information corresponding to the PMI to the first network device, so that the first network device determines phase shift matrix indication information for the second network device according to the information reported by the terminal. After the first network device sends the phase shift matrix indication information to the second network device, the second network device is capable of performing a signal processing on transmitted signals from the first network device in accordance with the phase shift matrix indication information.

In summary, according to the precoding method provided in the example of the present disclosure, the terminal reports the PMI for the second network device (an RIS) and the beam quality information corresponding to the PMI to the first network device, so that the first network device is used to determine the phase shift matrix indication information for the second network device and send the phase shift matrix indication information to the second network device. Therefore, the second network device is capable of performing the signal processing on the transmitted signals from the first network device in accordance with the phase shift matrix indication information. Through the simple data processing in the present disclosure, the phase shift matrix indication information including precoding information is determined in the first network device, so that the second network device may directly perform a phase shift matrix configuration according to the phase shift matrix indication information and perform the signal processing on the transmitted signals from the first network device. Therefore, the present disclosure can avoid iterative calculations and complex algorithms, thereby simplifying the precoding process of the RIS, reducing the precoding complexity, and improving the precoding efficiency.

Corresponding to the precoding methods provided in the mentioned examples, a complete implementation process of the present disclosure may include the following.
(1) One or more terminals report one or more PMIs for a second network device and beam quality information corresponding to the one or more PMIs to a first network device.

Particularly, the beam quality information corresponding to the PMI reflects a quality of a beam transmission. In specific application scenarios, it may be measured by using an RSRP, an SINR, an RSRQ, an RSSI, etc. For example, as a possible implementation, one piece of the mentioned information may be taken as the beam quality information corresponding to the PMI; and as a possible implementation, multiple pieces of the mentioned information may be integrated in accordance with a preset algorithm (such as a weighted integration) to obtain the beam quality information corresponding to the PMI.
(2) First reflection angle information or first transmission angle information corresponding to each terminal is determined according to the one or more PMIs for the second network device and the beam quality information corresponding to the one or more PMI reported by the one or more terminals.
(3) Second reflection angle information or second transmission angle information of the second network device is determined according to the first reflection angle information or the first transmission angle information of a plurality of terminals, the PMIs for the second network device reported by the plurality of terminals and the beam quality information corresponding to the PMIs reported by the plurality of terminals.

With respect to the example of the present disclosure, it may refer to the relevant description about step 302 or 702 in the example, which will not be repeated here.
(4) A first phase shift matrix is determined according to incidence angle information of one or more transmitted signals and the second reflection angle information or the second transmission angle information of the second network device.
(5) A second phase shift matrix is obtained by quantizing a phase shift of each unit of the first phase shift matrix to a phase shift supported by an RIS.
(6) The first network device sends the phase shift matrix indication information to the second network device.

Particularly, the phase shift matrix indication information may include any one of first phase shift matrix indication information, second phase shift matrix indication information, third phase shift matrix indication information or fourth phase shift matrix indication information. The first phase shift matrix indication information may include the incidence angle information of the one or more transmitted signals, the PMIs for the second network device reported by the plurality of terminals and the beam quality information corresponding to the PMIs reported by the plurality of terminals. The second phase shift matrix indication information may include the incidence angle information of the one or more transmitted signals and the second reflection angle information or the second transmission angle information of the second network device. The third phase shift matrix indication information may include a phase shift matrix of the second network device. The fourth phase shift matrix indication information may include a phase shift matrix PMI.

With respect to the example of the present disclosure, as a possible implementation, when the first network device determines the first phase shift matrix indication information and sends the first phase shift matrix indication information to the second network device (see steps 201 to 204 of the example), the corresponding steps (2) to (5) may be performed on the second network device (see steps 701 to 706 in the example).

As a possible implementation, when the first network device determines the second phase shift matrix indication information and sends the second phase shift matrix indication information to the second network device (see steps 301 to 304 in the example), the corresponding steps (4) to (5) may be performed on the second network device (see steps 801 to 805 in the example).

As a possible implementation, when the first network device determines the third phase shift matrix indication information and sends the third phase shift matrix indication information to the second network device (see steps 401 to 406 in the example), the second network device may directly receive the second phase shift matrix and then continue to perform step (7) (see steps 902 to 903 in the example).

As a possible implementation, when the first network device determines the fourth phase shift matrix indication information and sends the fourth phase shift matrix indication information to the second network device (see steps 501 to 506 in the example), the second network device may perform steps 1002 to 1003 in the example to obtain the second phase shift matrix of the second network device, and then further perform steps 1004 to 1005 in the example to determine the phase shift matrix configuration according to the second phase shift matrix, and perform a signal processing on transmitted signals from the first network device in accordance with the phase shift matrix configuration. The signal processing includes a signal reflection processing or a signal transmission processing.
(7) The second network device performs the signal processing on the transmitted signals from the first network device in accordance with the received phase shift matrix indication information.

In summary, according to the precoding method provided in the example of the present disclosure, the phase shift matrix indication information including precoding information is capable of being determined in the first network device or the second network device through the simple data processing, which avoids iterative calculations and complex algorithms, thereby simplifying the precoding process of the RIS, reducing the precoding complexity, and improving the precoding efficiency.

In the foregoing examples provided in the present disclosure, the methods provided in the examples of the present disclosure are introduced from the perspectives of the first network device (the base station), the second network device (the RIS), and the terminal separately. In order to implement the various functions in the methods provided in the foregoing examples of the present disclosure, the first network device (the base station), the second network device (the RIS) and the terminal may include hardware structures and software modules, and implement the various functions in the form of the hardware structures, the software modules, or a combination of the hardware structures and the software modules. A certain function among the various functions may be performed in the form of the hardware structures, the software modules, or the combination of the hardware structures and the software modules.

Corresponding to the precoding methods provided in the foregoing examples, the present disclosure also provides a first network device, a second network device and a terminal. Since the first network device, the second network device and the terminal provided in the examples of the present disclosure correspond to the precoding methods provided in the foregoing examples, the implementations of the precoding methods are also applicable to the first network device, the second network device and the terminal provided in the examples and will not be described in detail in these examples.

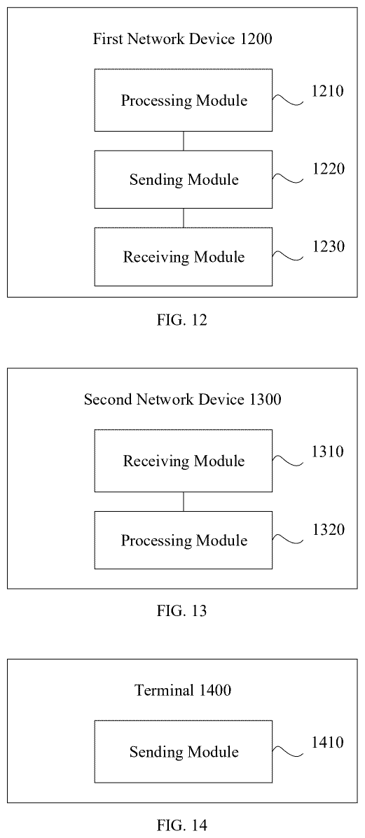

FIG. 12 is a schematic structural diagram of a first network device 1200 provided in an example of the present disclosure.

As illustrated in FIG. 12, the first network device 1200 may include a processing module 1210 and a sending module 1220:

The processing module 1210 may be configured to determine phase shift matrix indication information for a second network device.

The sending module 1220 may be configured to send the phase shift matrix indication information to the second network device.

In some examples of the present disclosure, the phase shift matrix indication information includes first phase shift matrix indication information. The first phase shift matrix indication information includes incidence angle information of one or more transmitted signals, PMIs for the second network device reported by a plurality of terminals and beam quality information corresponding to the PMIs reported by the plurality of terminals. The processing module 1210 may be configured to determine the incidence angle information of the one or more transmitted signals, and take the incidence angle information of the one or more transmitted signals, the PMIs for the second network device reported by the plurality of terminals and the beam quality information corresponding to the PMIs reported by the plurality of terminals as the first phase shift matrix indication information.

In some examples of the present disclosure, the phase shift matrix indication information includes second phase shift matrix indication information. The second phase shift matrix indication information includes the incidence angle information of one or more transmitted signals and second reflection angle information or second transmission angle information of the second network device. The processing module 1210 may be configured to determine the incidence angle information of the one or more transmitted signals, determine the second reflection angle information or the second transmission angle information of the second network device according to the PMIs for the second network device and the beam quality information corresponding to the PMIs reported by the plurality of terminals, and take the incidence angle information of the one or more transmitted signals and the second reflection angle information or the second transmission angle information of the second network device as the second phase shift matrix indication information.

In some examples of the present disclosure, the phase shift matrix indication information includes third phase shift matrix indication information. The third phase shift matrix indication information includes a second phase shift matrix. The processing module 1210 may be configured to determine the second reflection angle information or the second transmission angle information of the second network device according to the PMIs for the second network device and the beam quality information corresponding to the PMIs reported by the plurality of terminals, determine a first phase shift matrix according to incidence angle information of one or more transmitted signals and the second reflection angle information or the second transmission angle information of the second network device, obtain a second phase shift matrix of the second network device by performing a phase shift quantization processing on the first phase shift matrix, and take the second phase shift matrix as the third phase shift matrix indication information.

In some examples of the present disclosure, the phase shift matrix indication information includes fourth phase shift matrix indication information. The fourth phase shift matrix indication information includes a phase shift matrix PMI. The processing module 1210 may be configured to determine the second reflection angle information or the second transmission angle information of the second network device according to the PMIs for the second network device and the beam quality information corresponding to the PMIs reported by the plurality of terminals, determine a first phase shift matrix according to incidence angle information of one or more transmitted signals and the second reflection angle information or the second transmission angle information of the second network device, determine the phase shift matrix PMI corresponding to the first phase shift matrix, and take the phase shift matrix PMI as the fourth phase shift matrix indication information.

In some examples of the present disclosure, as illustrated in FIG. 12, the first network device 1200 further includes a receiving module 1230.

The receiving module 1230 may be configured to receive the PMIs for the second network device and the beam quality information corresponding to the PMIs reported by the plurality of terminals.

In some examples of the present disclosure, the processing module 1210 may be configured to determine first reflection angle information or first transmission angle information of the plurality of terminals according to the PMIs for the second network device reported by the plurality of terminals, and determine the second reflection angle information or the second transmission angle information of the second network device according to the first reflection angle information or the first transmission angle information of the plurality of terminals, the PMIs for the second network device reported by the plurality of terminals and the beam quality information corresponding to the PMIs reported by the plurality of terminals.

In some examples of the present disclosure, the processing module 1210 may be configured to determine beam weights corresponding to the terminals based on the PMIs for the second network device and the beam quality information corresponding to the PMIs reported by the plurality of terminals, and obtain the second reflection angle information or the second transmission angle information of the second network device by performing a weighted processing on angle values of the first reflection angle information or the first transmission angle information of the plurality of terminals using the beam weights corresponding to the terminals.

In some examples of the present disclosure, the processing module 1210 may be configured to determine, according to the PMIs for the second network device and the beam quality information corresponding to the PMIs reported by the plurality of terminals, a piece of first reflection angle information or first transmission angle information that meets a preset condition among the first reflection angle information or the first transmission angle information of the plurality of terminals as the second reflection angle information or the second transmission angle information of the second network device.

In some examples of the present disclosure, the sending module 1220 may be configured to send any one of the first phase shift matrix indication information, the second phase shift matrix indication information, the third phase shift matrix indication information, or the fourth phase shift matrix indication information to the second network device.

FIG. 13 is a schematic structural diagram of a second network device 1300 provided in an example of the present disclosure.

As illustrated in FIG. 13, the second network device 1300 may include a receiving module 1310 and a processing module 1320.

The receiving module 1310 may be configured to receive phase shift matrix indication information sent by a first network device.

The processing module 1320 may be configured to perform a signal processing on one or more transmitted signals from the first network device in accordance with the phase shift matrix indication information.

In some examples of the present disclosure, the phase shift matrix indication information includes first phase shift matrix indication information. The first phase shift matrix indication information includes incidence angle information of the one or more transmitted signals, PMIs for the second network device reported by a plurality of terminals and beam quality information corresponding to the PMIs reported by the plurality of terminals. The receiving module 1310 may be configured to receive, from the first network device, the incidence angle information of the one or more transmitted signals, the PMIs for the second network device reported by the plurality of terminals and the beam quality information corresponding to the PMIs reported by the plurality of terminals.

In some examples of the present disclosure, the processing module 1320 may be configured to determine second reflection angle information or second transmission angle information of the second network device according to the PMIs for the second network device and the beam quality information corresponding to the PMIs reported by the plurality of terminals, determine a first phase shift matrix according to the incidence angle information of the one or more transmitted signals and the second reflection angle information or the second transmission angle information of the second network device, obtain a second phase shift matrix of the second network device by performing a phase shift quantization processing on the first phase shift matrix, determine a phase shift matrix configuration according to the second phase shift matrix, and perform the signal processing on transmitted signals from the first network device in accordance with the phase shift matrix configuration. The signal processing includes a signal reflection processing or a signal transmission processing.

In some examples of the present disclosure, the processing module 1320 may be configured to determine first reflection angle information or first transmission angle information of the plurality of terminals according to the PMIs for the second network device reported by the plurality of terminals, and determine the second reflection angle information or the second transmission angle information of the second network device according to the first reflection angle information or the first transmission angle information of the plurality of terminals, the PMIs for the second network device reported by the plurality of terminals and the beam quality information corresponding to the PMIs reported by the plurality of terminals.

In some examples of the present disclosure, the processing module 1320 may be configured to determine beam weights corresponding to the terminals based on the PMIs for the second network device and the beam quality information corresponding to the PMIs reported by the plurality of terminals, and obtain the second reflection angle information or the second transmission angle information of the second network device by performing a weighted processing on angle values of the first reflection angle information or the first transmission angle information of the plurality of terminals using the beam weights corresponding to the terminals.

In some examples of the present disclosure, the processing module 1320 may be configured to determine, according to the PMIs for the second network device and the beam quality information corresponding to the PMIs reported by the plurality of terminals, a piece of first reflection angle information or first transmission angle information that meets a preset condition among the first reflection angle information or the first transmission angle information of the plurality of terminals as the second reflection angle information or the second transmission angle information of the second network device.

In some examples of the present disclosure, the phase shift matrix indication information includes second phase shift matrix indication information. The second phase shift matrix indication information includes incidence angle information of the one or more transmitted signals and second reflection angle information or second transmission angle information of the second network device. The receiving module 1310 may be configured to receive, from the first network device, the incidence angle information of the one or more transmitted signals and the second reflection angle information or the second transmission angle information of the second network device.

In some examples of the present disclosure, the processing module 1320 may be configured to determine a first phase shift matrix according to the incidence angle information of the one or more transmitted signals and the second reflection angle information or the second transmission angle information of the second network device, obtain a second phase shift matrix of the second network device by performing a phase shift quantization processing on the first phase shift matrix, determine a phase shift matrix configuration according to the second phase shift matrix, and perform the signal processing on the transmitted signals from the first network device in accordance with the phase shift matrix configuration. The signal processing includes a signal reflection processing or a signal transmission processing.

In some examples of the present disclosure, the phase shift matrix indication information includes third phase shift matrix indication information. The third phase shift matrix indication information includes a second phase shift matrix. The receiving module 1310 may be configured to receive the second phase shift matrix sent by the first network device.

In some examples of the present disclosure, the processing module 1320 may be configured to determine a phase shift matrix configuration according to the second phase shift matrix, and perform the signal processing on the transmitted signals from the first network device in accordance with the phase shift matrix configuration. The signal processing includes a signal reflection processing or a signal transmission processing.

In some examples of the present disclosure, the phase shift matrix indication information includes fourth phase shift matrix indication information. The fourth phase shift matrix indication information includes a phase shift matrix PMI. The receiving module 1310 may be configured to receive the phase shift matrix PMI sent by the first network device.

In some examples of the present disclosure, the processing module 1320 may be configured to determine a first phase shift matrix according to the phase shift matrix PMI, obtain a second phase shift matrix of the second network device by performing a phase shift quantization processing on the first phase shift matrix, determine a phase shift matrix configuration according to the second phase shift matrix, and perform the signal processing on the transmitted signals from the first network device in accordance with the phase shift matrix configuration. The signal processing includes a signal reflection processing or a signal transmission processing.

FIG. 14 is a schematic diagram of the structure of a terminal 1400 provided according to an example of the present disclosure.

As illustrated in FIG. 14, the terminal 1400 may include a sending module 1410.

The sending module 1410 is configured to report a PMI for a second network device and beam quality information corresponding to the PMI to a first network device.

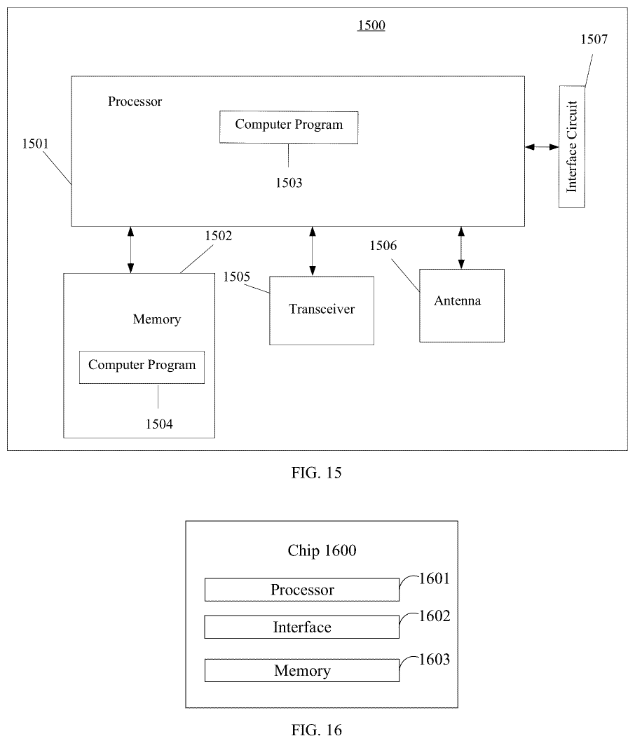

Referring to FIG. 15, it is a schematic structural diagram of a communication device 1500 provided in an example of the present disclosure. The communication device 1500 may be a network device, may be user equipment, may be a chip, a chip system or a processor that supports the network device to implement the foregoing methods, or may be a chip, a chip system or a processor that supports the user equipment to implement the foregoing methods. The apparatus may be configured to implement the methods described in the foregoing method examples, whose details may refer to the descriptions of the foregoing method examples.

The communications device 1500 may include one or more processors 1501. The processor 1501 may be a general processor, a dedicated processor or the like. For example, it may be a baseband processor or a central processor. The baseband processor may be configured to process communication protocols and communication data, and the central processor may be configured to control the communication device (such as a base station, a baseband chip, a terminal device, a terminal device chip, a distributed unit (DU) or a centralized unit (CU), etc.) to execute a computer program and process data of the computer program.

Alternatively, or additionally, the communication device 1500 may further include one or more memories 1502, on which a computer program 1504 may be stored, and the one or more processors 1501 execute the computer program 1504, so as to enable the communication device 1500 to perform the methods described in the foregoing method examples. Alternatively, or additionally, the one or more memories 1502 may further store data. The communication device 1500 and the one or more memories 1502 may be set separately or integrated together.

Alternatively, or additionally, the communication device 1500 may further include one or more transceivers 1505 and one or more antennas 1506. The transceiver 1505 may be referred to as a transceiving unit, a transceiving machine, or a transceiving circuit, etc., and is configured to implement a transmission and reception function. The transceiver 1505 may include a receiver and a transmitter. The receiver may be called a receiving machine or a receiving circuit for implementing a reception function, and the transmitter may be called a transmitting machine or a transmitting circuit for implementing a transmission function.

Alternatively, or additionally, the communication device 1500 may further include one or more interface circuits 1507. The one or more interface circuits 1507 are configured to receive and transmit code instructions to the one or more processors 1501. The one or more processors 1501 execute the code instructions to enable the communication device 1500 to perform the methods described in the foregoing method examples.

In an implementation, the one or more processors 1501 may include the one or more transceivers for implementing the transmission and reception function. For example, the transceiver may be a transceiving circuit, or an interface, or an interface circuit. The transceiving circuit, interface or interface circuit for implementing the transmission and reception function may be separated or integrated together. The transceiver circuit, interface or interface circuit may be configured to read and write code/data. Alternatively, the transceiver circuit, interface or interface circuit may be configured to transmit or transfer signals.

In an implementation, the one or more processors 1501 may store a computer program 1503, and the computer program 1503 runs on the one or more processors 1501 to enable the communication device 1500 to perform the methods described in the foregoing method examples. The computer program 1503 may be solidified in the one or more processors 1501. In this case, the one or more processors 1501 may be implemented by hardware.

In an implementation, the communication device 1500 may include a circuit, and the circuit may implement the function of transmitting, receiving or communicating in the foregoing method examples. The one or more processors and transceivers described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The one or more processors and transceivers may also be fabricated with various IC processing technologies such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication device described in the above examples may be the network device or the user equipment. However, the communication device described in the present disclosure is not limited by such a range, and the structure of the communication device may not be limited to FIG. 15. The communication device may be a stand-alone device or may be a part of a larger device. For example, the communication device may be:
(1) stand-alone ICs, chips, or chip systems or subsystems;
(2) a set of one or more ICs, which may alternatively or additionally include one or more storage components for storing data and computer programs;
(3) ASIC, such as a modem;
(4) modules that may be embedded in other devices;
(5) a receiver, a terminal device, an intelligent terminal device, a cellular phone, a wireless device, a handset, a mobile unit, a vehicle-mounted device, a network device, a cloud device, an artificial intelligence device, etc.;
(6) others and so on.

For the case where the communications device may be a chip or a chip system, it may refer to the schematic structural diagram of the chip illustrated in FIG. 16. The chip illustrated in FIG. 16 includes one or more processors 1601 and one or more interfaces 1602. The number of the one or more processors 1601 may be one or more than one, and the number of the one or more interfaces 1602 may be more than one.

Alternatively, or additionally, the chip also includes one or more memories 1603 for storing necessary computer programs and data.

Those skilled in the art may also understand that various illustrative logical blocks and steps presented in the examples of the present disclosure may be implemented through electronic hardware, computer software, or a combination of the both. Whether such functions are implemented through the hardware or the software depends on specific applications and overall system design requirements. Those skilled in the art may use various approaches to implement the described function for each specific application. However, such implementation should not be understood as exceeding the protection scope of the examples of the present disclosure.

The present disclosure also provides a readable storage medium on which instructions are stored. The instructions, when executed by a computer, implement the functions of any one of the foregoing method examples.

The present disclosure also provides a computer program product, which implements the functions of any one of the foregoing method examples when being executed by a computer.

In the above examples, it can be implemented in whole or in part by software, hardware, firmware, or any combination thereof. When implemented in software, it may be implemented in whole or in part in the form of a computer program product. The computer program product includes one or more computer programs. When the computer programs are loaded and executed on a computer, the processes or functions according to the examples of the present disclosure are generated in whole or in part. The computer may be a general-purpose computer, a dedicated computer, a computer network, or another programmable device. The computer programs may be stored in a computer-readable storage medium or transmitted from one computer-readable storage medium to another computer-readable storage medium, for example, the computer programs may be transmitted from a website site, a computer, a server or a data center via wire (for example, coaxial cable, optical fiber, digital subscriber line (DSL)) or wireless (for example, infrared, wireless, microwave, etc.) to another website site, another computer, another server, or another data center. The computer-readable storage medium may be any available medium that can be accessed by a computer or a data storage device such as a server and a data center integrating one or more available media. The available medium may be a magnetic medium (for example, a floppy disk, a hard disk, a magnetic tape), an optical medium (for example, a high-density digital video disc (DVD)), or a semiconductor medium (for example, a solid state disk (SSD)), etc.

Those of ordinary skill in the art may understand that the division of first, second, and other numbers involved in the present disclosure are only for convenience of description, instead of limiting the scope of the examples of the present disclosure or indicating a sequential order.

“At least one” in the present disclosure may also be described as “one or more”. The “more” may refer to two, three, four or more, which is not limited in the present disclosure. In the examples of the present disclosure, for a technical character, its technical features are distinguished by “first,” “second,” “third,” “A,” “B,” “C,” and “D,” etc. There is no sequential order or size order between the technical features described by the “first,” “second,” “third,” “A,” “B,” “C,” and “D.”

As used herein, the terms “machine-readable medium” and “computer-readable medium” refer to any computer program product, device, and/or apparatus for providing machine instructions and/or data to a programmable processor (e.g., a magnetic disk, an optical disk, memory, a programmable logic device (PLD)), including a machine-readable medium that receives machine instructions as machine-readable signals. The term “machine-readable signal” refers to any signal for providing machine instructions and/or data to the programmable processor.

The systems and techniques described herein may be implemented in a computing system including a back-end component (e.g., as a data server), in a computing system including a middleware component (e.g., an application server), in a computing system including a front-end component (e.g., a user computer having a graphical user interface or a web browser through which a user can interact with implementations of the systems and techniques described herein), or in a computing system including any combination of such back-end component, such middleware component or such front-end component. The components of the system may be interconnected in any form or medium of digital data communication (e.g., a communication network). Examples of the communication network include a local area network (LAN), a wide area network (WAN), and Internet.

The computing system may include a client and a server. The client and the server are generally remote from each other and typically interact through the communication network. The relationship between the client and the server is established by computer programs running on the respective computers and having a client-server relationship with each other.

It is to be understood that the processes illustrated above may be used in various forms, with one or more steps being reordered, added or deleted. For example, the steps described in the present disclosure may be performed in parallel, in sequence, or in a different order, which is not limited herein as long as the expected results of the technical solutions disclosed in the present disclosure can be achieved.

In addition, it is to be understood that the various examples of the present disclosure may be implemented individually or in combination with other examples when the solution permits.

Those skilled in the art may appreciate that the units and algorithm steps of each illustration described in conjunction with the examples disclosed herein may be implemented by electronic hardware, computer software, or a combination of computer software and electronic hardware. Whether these functions are performed by hardware or by software depends on the specific application and the design constraint conditions of the technical solution. Those skilled in the art may adopt a different method for each specific application to implement the described functions, which, however, should not be considered as being beyond the scope of the present disclosure.

Those skilled in the art may clearly understand that, for the convenience and brevity of description, the specific working processes of the systems, apparatuses, and units described above may refer to the corresponding processes in the foregoing method examples and will not be repeated here.

The foregoing description is merely specific implementations of the present disclosure, but the protection scope of the present disclosure is not limited thereto, and their variations or replacements within the technical scope disclosed in the present disclosure, which is readily conceivable by any person skilled in the art, should be covered within the protection scope of the present disclosure. Therefore, the protection scope of the present disclosure should be based on the protection scope of the claims.

1. A precoding method, performed by a first network device, comprising:
determining phase shift matrix indication information for a second network device; and
sending the phase shift matrix indication information to the second network device.

2. The method according to claim 1, wherein the phase shift matrix indication information comprises first phase shift matrix indication information, wherein the first phase shift matrix indication information comprises incidence angle information of one or more transmitted signals, precoding matrix indicators (PMIs) for the second network device reported by a plurality of terminals and beam quality information corresponding to the PMIs reported by the plurality of terminals, and wherein determining the phase shift matrix indication information for the second network device comprises:
determining the incidence angle information of the one or more transmitted signals; and
taking the incidence angle information of the one or more transmitted signals, the PMIs for the second network device reported by the plurality of terminals and the beam quality information corresponding to the PMIs reported by the plurality of terminals as the first phase shift matrix indication information.

3. The method according to claim 1, wherein the phase shift matrix indication information comprises second phase shift matrix indication information, wherein the second phase shift matrix indication information comprises incidence angle information of one or more transmitted signals and second reflection angle information or second transmission angle information of the second network device, and wherein determining the phase shift matrix indication information for the second network device comprises:
determining the incidence angle information of the one or more transmitted signals;
determining the second reflection angle information or the second transmission angle information of the second network device according to precoding matrix indicators (PMIs) for the second network device and beam quality information corresponding to the PMIs reported by a plurality of terminals; and
taking the incidence angle information of the one or more transmitted signals and the second reflection angle information or the second transmission angle information of the second network device as the second phase shift matrix indication information.

4. The method according to claim 1, wherein the phase shift matrix indication information comprises third phase shift matrix indication information, wherein the third phase shift matrix indication information comprises a second phase shift matrix, and wherein determining the phase shift matrix indication information for the second network device comprises:
determining second reflection angle information or second transmission angle information of the second network device according to precoding matrix indicators (PMIs) for the second network device and beam quality information corresponding to the PMIs reported by a plurality of terminals;
determining a first phase shift matrix according to incidence angle information of one or more transmitted signals and the second reflection angle information or the second transmission angle information of the second network device;
obtaining a second phase shift matrix of the second network device by performing a phase shift quantization processing on the first phase shift matrix; and
taking the second phase shift matrix as the third phase shift matrix indication information.

5. The method according to claim 1, wherein the phase shift matrix indication information comprises fourth phase shift matrix indication information, wherein the fourth phase shift matrix indication information comprises a phase shift matrix precoding matrix indicator (PMI), and wherein determining the phase shift matrix indication information for the second network device comprises:
determining second reflection angle information or second transmission angle information of the second network device according to precoding matrix indicators (PMIs) for the second network device and beam quality information corresponding to the PMIs reported by a plurality of terminals;
determining a first phase shift matrix according to incidence angle information of one or more transmitted signals and the second reflection angle information or the second transmission angle information of the second network device;
determining the phase shift matrix PMI corresponding to the first phase shift matrix; and
taking the phase shift matrix PMI as the fourth phase shift matrix indication information.

6. The method according to claim 1, further comprising:
receiving precoding matrix indicators (PMIs) for the second network device and beam quality information corresponding to the PMIs reported by a plurality of terminals.

7. The method according to claim 1, wherein second reflection angle information or second transmission angle information of the second network device is determined according to precoding matrix indicators (PMIs) for the second network device and beam quality information corresponding to the PMIs reported by a plurality of terminals, comprising:
determining first reflection angle information or first transmission angle information of the plurality of terminals according to the PMIs for the second network device reported by the plurality of terminals; and
determining the second reflection angle information or the second transmission angle information of the second network device according to the first reflection angle information or the first transmission angle information of the plurality of terminals, the PMIs for the second network device reported by the plurality of terminals and the beam quality information corresponding to the PMIs reported by the plurality of terminals.

8. The method according to claim 7, wherein determining the second reflection angle information or the second transmission angle information of the second network device according to the first reflection angle information or the first transmission angle information of the plurality of terminals, the PMIs for the second network device reported by the plurality of terminals and the beam quality information corresponding to the PMIs reported by the plurality of terminals comprises:
determining beam weights corresponding to the plurality of terminals based on the PMIs for the second network device and the beam quality information corresponding to the PMIs reported by the plurality of terminals; and
obtaining the second reflection angle information or the second transmission angle information of the second network device by performing a weighted processing on angle values of the first reflection angle information or the first transmission angle information of the plurality of terminals using the beam weights corresponding to the plurality of terminals;
or
determining, according to the PMIs for the second network device and the beam quality information corresponding to the PMIs reported by the plurality of terminals, a piece of first reflection angle information or first transmission angle information that meets a preset condition among the first reflection angle information or the first transmission angle information of the plurality of terminals as the second reflection angle information or the second transmission angle information of the second network device.

9. (canceled)

10. The method according to 1, wherein sending the phase shift matrix indication information to the second network device comprises:
sending any one of first phase shift matrix indication information, second phase shift matrix indication information, third phase shift matrix indication information, or fourth phase shift matrix indication information to the second network device.

11. A precoding method, performed by a second network device, comprising:
receiving phase shift matrix indication information sent by a first network device; and
performing a signal processing on one or more transmitted signals from the first network device in accordance with the phase shift matrix indication information.

12. The method according to claim 11, wherein the phase shift matrix indication information comprises first phase shift matrix indication information, wherein the first phase shift matrix indication information comprises incidence angle information of the one or more transmitted signals, precoding matrix indicators (PMIs) for the second network device reported by a plurality of terminals and beam quality information corresponding to the PMIs reported by the plurality of terminals, and wherein receiving the phase shift matrix indication information sent by the first network device comprises:
receiving, from the first network device, the incidence angle information of the one or more transmitted signals, the PMIs for the second network device reported by the plurality of terminals and the beam quality information corresponding to the PMIs reported by the plurality of terminals; and
wherein performing the signal processing in accordance with the phase shift matrix indication information comprises:
determining second reflection angle information or second transmission angle information of the second network device according to the PMIs for the second network device and the beam quality information corresponding to the PMIs reported by the plurality of terminals;
determining a first phase shift matrix according to the incidence angle information of the one or more transmitted signals and the second reflection angle information or the second transmission angle information of the second network device;
obtaining a second phase shift matrix of the second network device by/performing a phase shift quantization processing on the first phase shift matrix;
determining a phase shift matrix configuration according to the second phase shift matrix; and
performing the signal processing on transmitted signals from the first network device in accordance with the phase shift matrix configuration, wherein the signal processing comprises a signal reflection processing or a signal transmission processing.

13. (canceled)

14. The method according to claim 12, wherein determining the second reflection angle information or the second transmission angle information of the second network device according to the PMIs for the second network device and the beam quality information corresponding to the PMIs reported by the plurality of terminals comprises:
determining first reflection angle information or first transmission angle information of the plurality of terminals according to the PMIs for the second network device reported by the plurality of terminals; and
determining the second reflection angle information or the second transmission angle information of the second network device according to the first reflection angle information or the first transmission angle information of the plurality of terminals, the PMIs for the second network device reported by the plurality of terminals and the beam quality information corresponding to the PMIs reported by the plurality of terminals.

15. The method according to claim 14, wherein determining the second reflection angle information or the second transmission angle information of the second network device according to the first reflection angle information or the first transmission angle information of the plurality of terminals, the PMIs for the second network device reported by the plurality of terminals and the beam quality information corresponding to the PMIs reported by the plurality of terminals comprises:
determining beam weights corresponding to the plurality of terminals based on the PMIs for the second network device and the beam quality information corresponding to the PMIs reported by the plurality of terminals; and
obtaining the second reflection angle information or the second transmission angle information of the second network device by performing a weighted processing on angle values of the first reflection angle information or the first transmission angle information of the plurality of terminals using the beam weights corresponding to the plurality of terminals;
or
determining, according to the PMIs for the second network device and the beam quality information corresponding to the PMIs reported by the plurality of terminals, a piece of first reflection angle information or first transmission angle information that meets a preset condition among the first reflection angle information or the first transmission angle information of the plurality of terminals as the second reflection angle information or the second transmission angle information of the second network device.

16. (canceled)

17. The method according to claim 11, wherein the phase shift matrix indication information comprises second phase shift matrix indication information, wherein the second phase shift matrix indication information comprises incidence angle information of the one or more transmitted signals and second reflection angle information or second transmission angle information of the second network device, and wherein receiving the phase shift matrix indication information sent by the first network device comprises:
receiving, from the first network device, the incidence angle information of the one or more transmitted signals and the second reflection angle information or the second transmission angle information of the second network device; and
wherein performing the signal processing in accordance with the phase shift matrix indication information comprises:
determining a first phase shift matrix according to the incidence angle information of the one or more transmitted signals and the second reflection angle information or the second transmission angle information of the second network device;
obtaining a second phase shift matrix of the second network device by performing a phase shift quantization processing on the first phase shift matrix;
determining a phase shift matrix configuration according to the second phase shift matrix; and
performing the signal processing on transmitted signals from the first network device in accordance with the phase shift matrix configuration, wherein the signal processing comprises a signal reflection processing or a signal transmission processing.

18. (canceled)

19. The method according to claim 11, wherein the phase shift matrix indication information comprises third phase shift matrix indication information, wherein the third phase shift matrix indication information comprises a second phase shift matrix, and wherein receiving the phase shift matrix indication information sent by the first network device comprises:
receiving the second phase shift matrix sent by the first network device; and
wherein performing the signal processing in accordance with the phase shift matrix indication information comprises:
determining a phase shift matrix configuration according to the second phase shift matrix; and
performing the signal processing on transmitted signals from the first network device in accordance with the phase shift matrix configuration, wherein the signal processing comprises a signal reflection processing or a signal transmission processing.

20. (canceled)

21. The method according to claim 11, wherein the phase shift matrix indication information comprises fourth phase shift matrix indication information, wherein the fourth phase shift matrix indication information comprises a phase shift matrix precoding matrix indicator (PMI), and wherein receiving the phase shift matrix indication information sent by the first network device comprises:
receiving the phase shift matrix PMI sent by the first network device; and
wherein performing the signal processing in accordance with the phase shift matrix indication information comprises:
determining a first phase shift matrix according to the phase shift matrix PMI;
obtaining a second phase shift matrix of the second network device by performing a phase shift quantization processing on the first phase shift matrix;
determining a phase shift matrix configuration according to the second phase shift matrix; and
performing the signal processing on transmitted signals from the first network device in accordance with the phase shift matrix configuration, wherein the signal processing comprises a signal reflection processing or a signal transmission processing.

22. (canceled)

23. A precoding method, performed by a terminal, comprising:
reporting a precoding matrix indicator (PMI) for a second network device and beam quality information corresponding to the PMI to a first network device.

24.-26. (canceled)

27. A communication device, comprising:
one or more transceivers;
one or more memories; and
one or more processors connected to the one or more transceivers and the one or more memories separately,
wherein the one or more processors are configured to perform the method according to claim 1.

28.-29. (canceled)

30. A communication device, comprising:
one or more transceivers;
one or more memories; and
one or more processors connected to the one or more transceivers and the one or more memories separately,
wherein the one or more processors are configured to perform the method according to claim 11.

31. A communication device, comprising:
one or more transceivers;
one or more memories; and
one or more processors connected to the one or more transceivers and the one or more memories separately,
wherein the one or more processors are configured to perform the method according to claim 23.
